(19) United States
(12) Patent Application Publication
(10) Pub. No.: US 2008/0276764 A1
(43) Pub. Date: Nov. 13, 2008

(54) Spanner with tension setting assembly

(76) Inventor: Chih-Ching Hsieh, Taichung City (TW)

Correspondence Address: Chih-Ching Hsieh, 235 Chung - Ho, Box 8-24, Taipei, TW

(21) Appl. No.: 11/801,119

(22) Filed: May 9, 2007

(51) Int. Cl. B25B 13/48

(52) U.S. Cl. 81/176.1

(57) ABSTRACT

A spanner with tension setting assembly, comprises at least one driving portion; a holding portion connected to the driving portion; a control portion installed at one side of the holding portion; an adjusting portion installed at the side of the holding portion and aside the processing and display portion; and a processing and display portion installed at the side of the holding portion; the processing and display portion receiving signals from the control portion and the adjusting portion for processing the signals and displaying processed results. The adjusting portion includes at least one setting section for setting the tensions and displaying functions of the processing and display portion.

### FIELD OF THE INVENTION

The present invention relates to electronic spanners, and particularly to a spanner with tension setting assembly, wherein by the structure of the adjusting portion and the function of the spanner, the functions of the electronic spanner can be set easily without needing complicated operations.

### BACKGROUND OF THE INVENTION

In some mechanical assemblies, the assembly of the screws must be locked with very high precision, for example, the screwing operations about the elements of the planes. In the locking of the elements of the planes, even an error to the locking of a screw occur, it is possible that a great plane accident will generate. Thus, the research members must test the assembly repeatedly so as to match the standard of the tensions. Thus electronic spanners are developed for these conditions. When the driving tension achieves the set value, then the machine is tested to determine whether it is matched to the standard. The operations are repeatedly.

However, in the prior art, several buttons are used to set about the operations of zeroing, adjustment of tensions, setting the display units, etc. The result is displayed through a display screen. Only several buttons are set on the electronic spanner due to the limit of the electronic spanner. Other than some buttons being assigned to special functions with one button having a corresponding function, other functions are actuated or set by pressing one button several times. However, this is tedious and difficult to the user because the user must memorize the operation sequences. Moreover, if one button is destroyed, other buttons are affected and thus they are also unused.

Furthermore in the prior art, only predetermined tension value is set and the tension value is displayed for each operation. If the tension value has achieved a predetermined value, the user presses the buttons again and again and records the operation results one by one for deriving an optimum tension value. The work load is increased greatly.

### SUMMARY OF THE INVENTION

Accordingly, the primary object of the present invention is to provide a spanner with tension setting assembly, wherein by the structure of the adjusting portion and the function of the spanner, the function of the electronic spanner can be set easily without needing complicated operations. The tensions for each operation can be recorded easily and an optimum value can be derived by reducing the applied tensions gradually.

To achieve above objects, the present invention provides a spanner with tension setting assembly, which comprises at least one driving portion; a holding portion connected to the driving portion; a control portion installed at one side of the holding portion; an adjusting portion installed at the side of the holding portion and aside the processing and display portion; and a processing and display portion installed at the side of the holding portion; the processing and display portion receiving signals from the control portion and the adjusting portion for processing the signals and displaying processed results. The adjusting portion includes at least one setting section for setting the tensions and displaying functions of the processing and display portion.

The control portion serves to set and control the actuation and de-actuation of the processing and display portion, reset tension force, adjust predetermined tension range, set the display unit of the tension, etc.

The adjusting portion includes a first setting section, a second setting section and a third setting section; by pressing the setting sections, the processing and display portion has different displaying functions.

In the mode of the first setting section, the processing and display portion displays values of tensions for each operation; and after several seconds, the display values flash and then is zeroed.

When in the mode of the second setting section, the processing and display portion displays the value of the tension at this operation and then locks this value; and the succeeding tension values will not be displayed.

When in the mode of the third setting section, the processing and display portion displays the value of the tension at this operation and then locks this values; the display is changed to another value of the tension until the another value of the tension is greater than that of the locked value and then the another value of the tension is locked.

The various objects and advantages of the present invention will be more readily understood from the following detailed description when read in conjunction with the appended drawing.

### BRIEF DESCRIPTION OF THE DRAWINGS

FIG. 1 is a perspective view of the spanner of the present invention.

FIG. 2 is a schematic view showing the operation according to the present invention.

FIGS. 3A and 3B are schematic view showing that the operation according to the first setting section of the present invention.

FIGS. 4A and 4B are schematic view showing that the operation according to the second setting section of the present invention.

FIGS. 5A and 5B are schematic view showing that the operation according to the third setting section of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

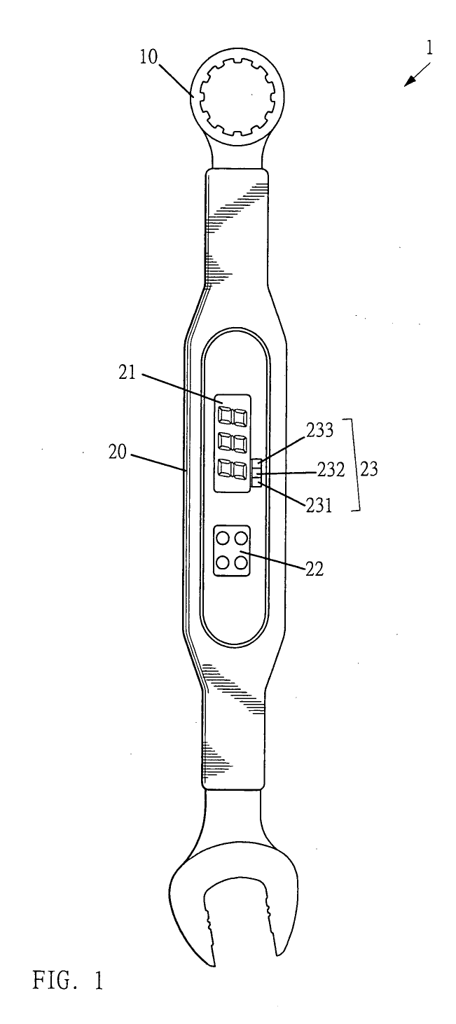

Referring to FIG. 1, the body 1 of the present invention is illustrated. The present invention has the following elements.

Two driving portions 10 are at two ends of the body 1.

A holding portion 20 is between the two driving portions 10.

A control portion 22 is installed at one side of the holding portion 20.

An adjusting portion 23 is installed at the side of the holding portion 20 and is aside the processing and display portion 21.

A processing and display portion 21 is installed at the side of the holding portion 20. The processing and display portion 21 receives signals from the control portion 22 and the adjusting portion 23 for processing the signals and displaying processed results.

The control portion 22 serves to set and control the actuation and de-actuation of the processing and display portion 21, reset tension force, adjust predetermined tension range, set the display unit of the tension, etc.

The adjusting portion 23 includes a first setting section 231, a second setting section 232 and a third setting section 233. By pressing the setting sections, the processing and display portion 21 has different displaying functions.

When in the mode of the first setting section 231, the processing and display portion 21 displays values of tensions for each operation. After several seconds, the display values flash and then is zeroed.

When in the mode of the second setting section 232, the processing and display portion 21 displays the value of the tension at this operation and then locks this value. The succeeding tension values will not be displayed.

When in the mode of the third setting section 233, the processing and display portion 21 displays the value of the tension at this operation and then locks this value. The display is changed to another value of the tension until the another value of the tension is greater than that of the locked value and then the another value of the tension is locked.

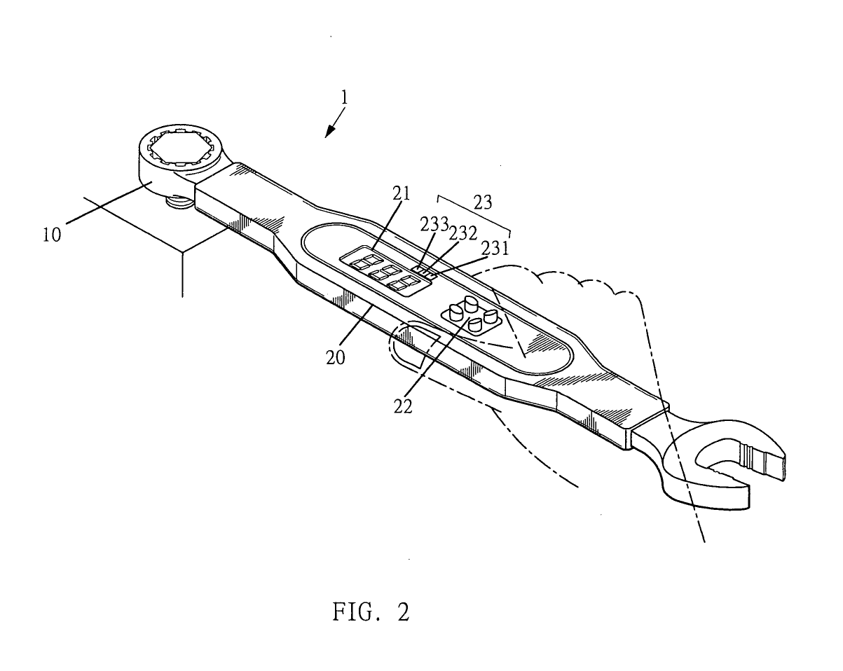

The effect of the present invention is illustrated in FIG. 2. When it is desired to have a correct locking force for a predetermined device, the body 1 is used to drive a screw of the device and the three sections are set with the functions of the processing and display portion 21 so as to make the user get desired tensions. An example about the operation will be described hereinafter.

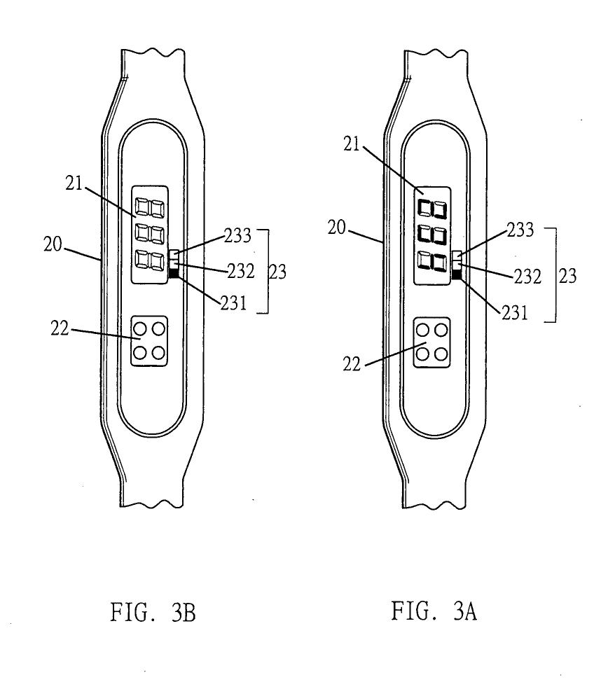

When in the mode of the first setting section 231, as shown in FIGS. 3A and 3B, the driving tension of 234 Nt-m (Newton-meter) is displayed by the processing and display portion 21. After several seconds of flashing, the display is zeroed. Thus the user can record the tension for each operation so as to get an optimum driving tension.

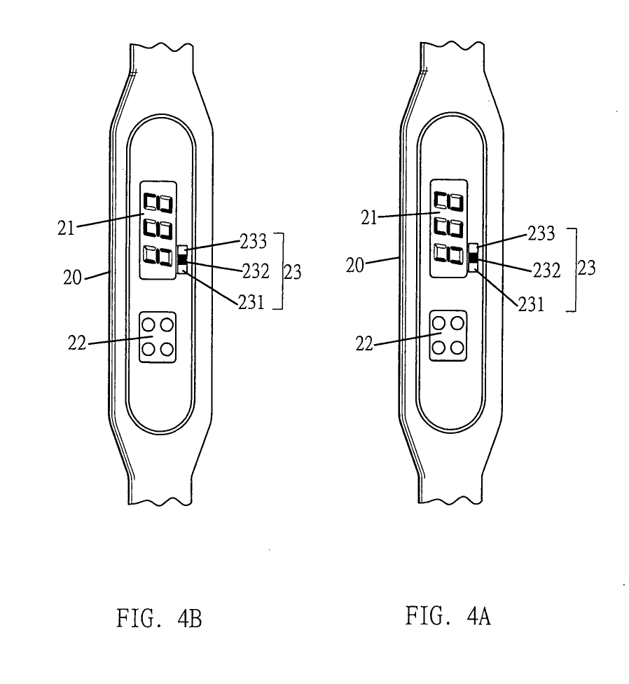

When in the mode of the second setting section 232, as shown in FIGS. 4A and 4B, the processing and display portion 21 displays the driving tension of 234 Nt-m for the operation and then the tension value is locked (displayed continuously). The processing and display portion 21 will not display the succeeding tensions. Therefore, the user can record important tension values.

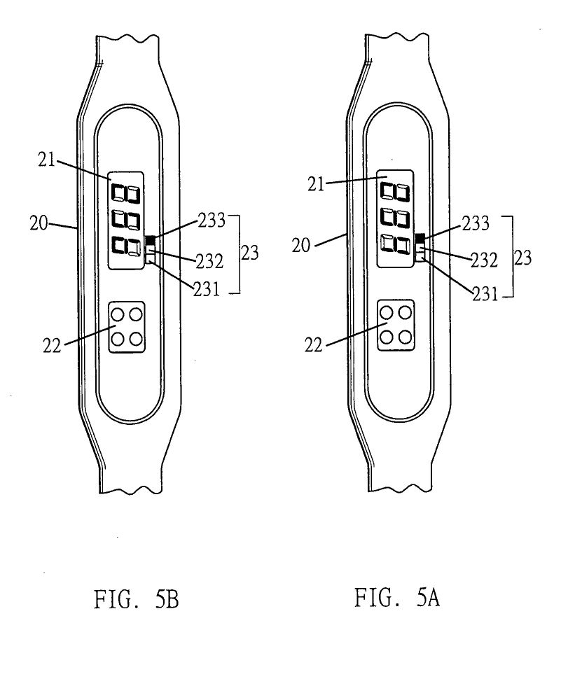

When in the mode of the third setting section 233, as shown in FIGS. 5A and 5B, the processing and display portion 21 displays the driving tension of 234 Nt-m for the operation and then the tension value is locked. If one succeeding tension value is greater than displayed tension value, the display tension will be changed to the new tension value, and the new tension value is locked so that the predict range of the tension value is reduced greatly. The user can record the tension values near an optimum tension.

Therefore, by the structure of the adjusting portion 23 and the function of the body 1, the function of the electronic spanner can be set easily without needing complicated operations. The tensions for each operation can be recorded easily and an optimum value can be derived by reducing the applied tensions gradually.

Moreover, the present invention need not press the control portion repeatedly as that in the prior art and thus the lifetime of the buttons is prolonged.

The arrangement of the elements of the present invention is not confined to that illustrated in above mentioned drawings. For example, in another arrangement, the set section can be replaced by a dialing wheel. By rotating the wheel to different positions, the mode of the set sections is selected.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A spanner with tension setting assembly, comprising:
at least one driving portion;
a holding portion connected to the driving portion;
a control portion installed at one side of the holding portion;
an adjusting portion installed at the side of the holding portion and aside the processing and display portion; and
a processing and display portion installed at the side of the holding portion; the processing and display portion receiving signals from the control portion and the adjusting portion for processing the signals and displaying processed results;
wherein the adjusting portion includes at least one setting section for setting the tensions and displaying functions of the processing and display portion.

2. The spanner with tension setting assembly as claimed in claim 1, wherein the control portion serves to set and control the actuation and de-actuation of the processing and display portion, reset tension force, adjust predetermined tension range, and set the display unit of the tension.

3. The spanner with tension setting assembly as claimed in claim 1, wherein the adjusting portion includes a first setting section, a second setting section and a third setting section; by pressing the setting sections, the processing and display portion has different displaying functions.

4. The spanner with tension setting assembly as claimed in claim 1, wherein in a mode of the first setting section, the processing and display portion displays a value of a tension for one operation; and after several seconds, the display values flash and then is zeroed.

5. The spanner with tension setting assembly as claimed in claim 1, wherein when in a mode of the second setting section, the processing and display portion displays a value of a tension for one operation and then locks this value; and the succeeding tension values will not be displayed.

6. The spanner with tension setting assembly as claimed in claim 1, wherein when in a mode of the third setting section, the processing and display portion displays a value of a tension for one operation and then locks this values; the display is changed to another value of the tension until the another value of the tension is greater than that of the locked value and then the another value of the tension is locked.
